(19) United States
(12) Patent Application Publication
(10) Pub. No.: US 2015/0172535 A1
(43) Pub. Date: Jun. 18, 2015

(54) WEBCAM AND METHOD FOR ADJUSTING ANGLE THEREOF

(71) Applicant: HON HAI PRECISION INDUSTRY CO., LTD., New Taipei (TW)

(72) Inventor: CHIH-YUAN YANG, New Taipei (TW)

(21) Appl. No.: 14/537,394

(22) Filed: Nov. 10, 2014

(30) Foreign Application Priority Data
Dec. 13, 2013 (TW) 102146290

(51) Int. Cl. H04N 5/232; H04N 1/00

(52) U.S. Cl. CPC H04N 5/23216; H04N 5/23203; H04N 1/00204; H04N 2201/0084

(57) ABSTRACT

A webcam includes an antenna, a storage unit and a processor. The storage unit stores a plurality of instructions. The processor is coupled to the storage unit, and executes the plurality of instructions to wirelessly receive angle information of a movement of a portable electronic device from an angle sensing unit of the portable electronic device by the antenna; and adjusts a shooting angle of the webcam based on the received angle information.

### CROSS-REFERENCE TO RELATED APPLICATIONS

This application claims priority to Taiwanese Patent Application No. 102146290 filed on Dec. 13, 2013, the contents of which are incorporated by reference herein.

### FIELD

The present disclosure relates to webcams, and particularly to a webcam and a method for adjusting an angle of the webcam.

### BACKGROUND

Webcams usually include a screen having a small size. It is inconvenient for user to adjust a shooting angle of the webcams by touching a number of keys arranged on the screen.

### BRIEF DESCRIPTION OF THE DRAWINGS

FIG. 1 is a block diagram of an embodiment of a webcam.

FIG. 2 is a flowchart of a method of adjusting the angle of the webcam implemented by the webcam of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

Embodiments of the present disclosure will be described with reference to the accompanying drawings.

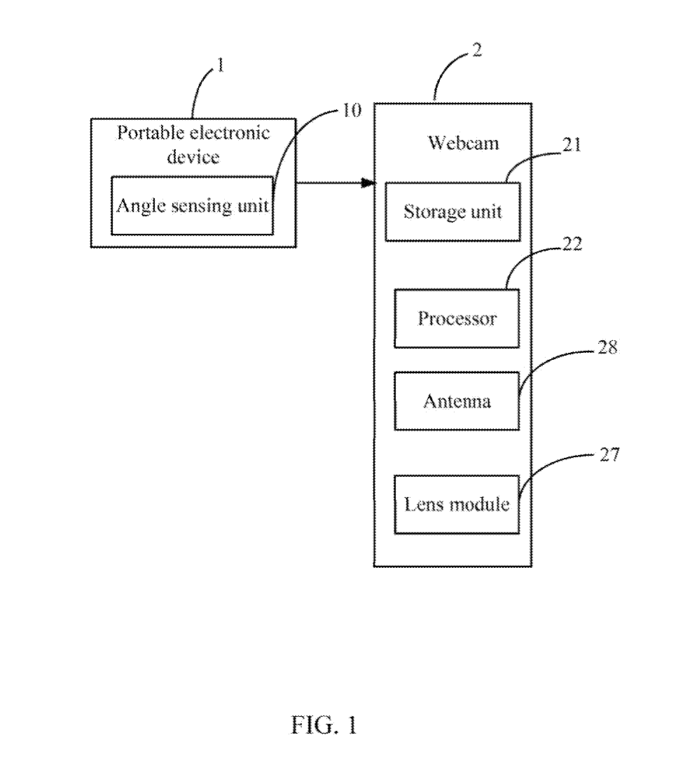

FIG. 1 illustrates an embodiment of a webcam 2. The webcam 2 includes an antenna 28, is wirelessly connected to a portable electronic device 1 by the antenna 28. In at least one embodiment, the portable electronic device 1 is a smart phone. In at least one embodiment, a first wireless transmitting module is arranged on the webcam 2, a second wireless transmitting module is arranged on the portable electronic device 1, and the portable electronic device 1 wirelessly transmits data to the webcam 2 through a matching of the first wireless transmitting module and the second wireless transmitting module. In another embodiment, two SIM cards are respectively inserted into the webcam 2 and the portable electronic device 1, the webcam 2 can receive message from the portable electronic device 1.

The portable electronic device 1 includes an angle sensing unit 10. The angle sensing unit 10 can be used to sense angle information of a movement of the portable electronic device 1.

The webcam 2 includes a storage unit 21 and a processor 22 coupled to the storage unit 21. The storage unit 21 stores a number of instructions. The processor 22 can execute the number of instruction to wirelessly receive the angle information of the movement of the portable electronic device 1 by the antenna 28. The processor 22 can further execute the number of instruction to adjust a shooting angle of the webcam based on the received angle information of the portable electronic device 1. In at least one embodiment, in order to adjust the shooting angle of the webcam 2, the processor 22 can only adjust an angle of a lens module 27 installed within the webcam 2 based on the received angle information of the portable electronic device 1, or can adjust the angle of the webcam 2 based on the received angle information of the portable electronic device 1. The lens module 27 is used for capturing images. In at least one embodiment, the processor 22 can be a central processing unit, a digital signal processor, or a single chip. In at least one embodiment, the storage unit can be an internal storage system, such as a flash memory, a random access memory (RAM) for temporary storage of information, and/or a read-only memory (ROM) for permanent storage of information. The storage unit 21 can also be a storage system, such as a hard disk, a storage card, or a data storage medium. In at least one embodiment, the storage unit can include two or more storage devices such that one storage device is a memory and the other storage device is a hard drive.

Furthermore, the webcam 2 can be switched between a normal mode and an adjusting mode. The webcam 2 further includes a switch 36. The switch 36 may switch the webcam 2 between the normal mode and the adjusting mode in response to a user instruction. The angle adjusting module 35 adjusts the shooting angle of the webcam 2 based on the received angle information when the webcam 2 is on the adjusting mode. The angle adjusting module 35 does not process the received angle information when the webcam 2 is on the normal mode.

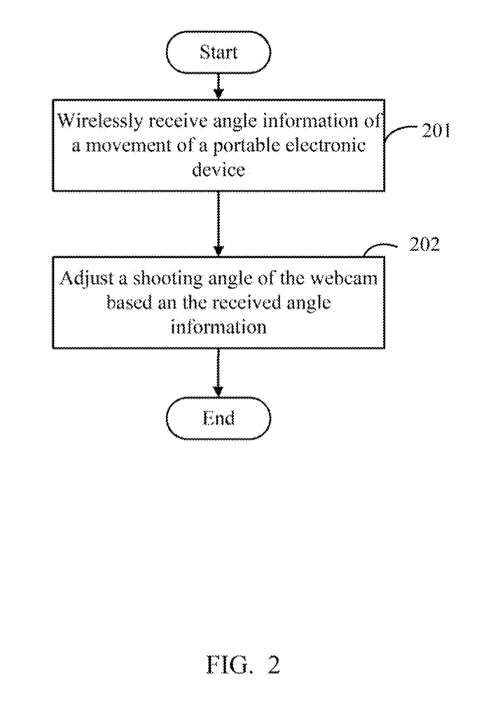

FIG. 2 is a flowchart of a method of adjusting the angle of the webcam implemented by the webcam of FIG. 1.

The method is provided by way of example, as there are a variety of ways to carry out the method. The method described below can be carried out using the configurations illustrated in FIG, 1, for example, and various elements of these figures are referenced in explaining the example method. Each block shown in FIG, 2 represents one or more processes, methods, or subroutines carried out in the example method. Additionally, the illustrated order of blocks is by example only and the order of the blocks can be changed. The example method can begin at block 201.

In block 201, a processor wirelessly receives angle information of a movement of a portable electronic device by an antenna.

In block 202, the processor adjusts a shooting angle of the webcam based on the received angle information.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A webcam comprising:
an antenna;
a storage unit configured to store a plurality of instructions; and
a processor coupled to the storage unit, the processor configured to execute the plurality of instructions to wirelessly receive angle information of a movement of a portable electronic device from an angle sensing unit of the portable electronic device by the antenna; and adjust a shooting angle of the webcam based on the received angle information.

2. The webcam as described in claim 1, further comprising a switch configured to switch the webcam between a normal mode and an adjusting mode, the processor further configured to adjust the shooting angle of the webcam based on the received angle information when the webcam is on the adjusting mode.

3. The webcam as described in claim 2, wherein the processor does not process the received angle information when the webcam is on the normal mode.

4. An angle adjusting method applied in a webcam comprising:
wirelessly receiving angle information of a movement of a portable electronic device from an angle sensing unit of the portable electronic device by an antenna of the webcam; and
adjusting a shooting angle of the webcam based on the received angle information.

5. The angle adjusting method as described in claim 4, further comprising:
switching the webcam between a normal mode and an adjusting mode; and
adjusting the shooting angle of the webcam based on the received angle information when the webcam is on the adjusting mode.

6. The angle adjusting method as described in claim 5, further comprising:
not processing the received angle information when the webcam is on the normal mode.
